(19) United States
(12) Patent Application Publication
(10) Pub. No.: US 2026/0112014 A1
(43) Pub. Date: Apr. 23, 2026

(54) INSPECTION SYSTEM FOR IMAGE DISPLAY DEVICES

(71) Applicant: SAMSUNG DISPLAY CO., LTD., YONGIN-SI (KR)

(72) Inventor: Young Sang HA, Yongin-si (KR)

(21) Appl. No.: 19/257,640

(22) Filed: Jul. 2, 2025

(30) Foreign Application Priority Data
Oct. 17, 2024 (KR) 10-2024-0141784

(51) Int. Cl. G06T 7/00; G06V 10/32; G06V 10/764

(52) U.S. Cl. CPC G06T 7/0002; G06V 10/32; G06V 10/764; G06T 2200/04; G06T 2207/10012; G06T 2207/20016; G06T 2207/20081; G06T 2207/30168

(57) ABSTRACT

An inspection system for image display devices including an image detection device configured to capture display images of display devices and to obtain test image data corresponding to the display images, and a quality analysis device configured to classify the test image data into a plurality of class labels based on predetermined distortion features using a machine learning program to obtain classified test image data, and to determine whether the display devices meet a quality standard by analyzing image quality evaluation values of the classified test image data classified.

This non-provisional patent application claims priority under 35 U.S.C. § 119 to Korean Patent Application No. 10-2024-0141784 filed on Oct. 17, 2024 in the Korean Intellectual Property Office, the entire disclosure of which is incorporated by reference herein in its entirety.

### BACKGROUND

### 1. Field of the Disclosure

The present disclosure relates to an inspection system for image display devices.

### 2. Discussion of the Related Art

In recent developments, display devices capable of rendering a three-dimensional (3D) image or capable of controlling a viewing-angle have been developed. These devices are capable of displaying the image in three dimensions using an optical member such as an optical lens. In some cases, a 3D image display device may separately display a left-eye image and a right-eye image in order to give a viewer 3D experiences through binocular parallax.

The 3D display technology are generally divided into two methods, which include a stereoscopic technique and an auto-stereoscopic technique. The stereoscopic technique utilizes parallax images between left and right eyes, which provide large stereoscopic effects. The stereoscopic technique may be implemented with or without glasses (glasses-free 3D).

For the stereoscopic technique implemented using glasses, a left-eye image and a right-eye image having different polarizations are displayed, so that a viewer with polarization glasses or shutter glasses can see 3D images. For glasses-free stereoscopic technique, an optical member such as a parallax barrier and a lenticular sheet is formed in the display device, and the optical axis of a left-eye image is separated from the optical axis of a right-eye image, so that a viewer can see 3D images.

However, a technical challenge remains in the accurate inspection and evaluation of the image display quality or visibility of a stereoscopic image display device. Conventional approach relies on apparatus or method designed for inspecting the image quality of a 2D image display device, which is inadequate for evaluating display devices that display 3D images. As a result, there is a need for a device or method capable of accurately analyzing the image quality for 2D images and 3D stereoscopic images.

### SUMMARY

According to an embodiment of the disclosure, an inspection system for image display devices including an image detection device configured to capture display images of display devices and to obtain test image data corresponding to the display images, and a quality analysis device configured to classify the test image data into a plurality of class labels based on predetermined distortion features using a machine learning program to obtain classified test image data, and to determine whether the display devices meet a quality standard by analyzing image quality evaluation values of the classified test image data classified.

According to an embodiment of the disclosure, an inspection system for image display devices including an image detection device configured to capture display images of display devices and to obtain test image data corresponding to the display images, and a quality analysis device configured to classify the test image data into a plurality of class labels based on predetermined distortion features using a machine learning program to obtain classified test image data, and to determine whether the display devices meet a quality standard by analyzing image quality evaluation values of the classified test image data classified, wherein the quality analysis device is configured to downsample the test image data to obtain downsampled test image data, and to classify the test image data based on the downsampled test image data.

According to an embodiment of the disclosure, a method for inspecting image quality of an image display device including obtaining, using an image detection device, test image data from a display image of an image display device; classifying, using a classification learning processor, the test image data to obtain classified test image data based on display characteristics of the test image data using a machine learning program; computing, using an image data analyzer, image quality evaluation metrics for the classified test image data; and determining, using the image data analyzer, whether the image display device meets a quality standard based on a comparison between the computed image quality evaluation metrics and predetermined reference metrics.

### BRIEF DESCRIPTION OF THE DRAWINGS

FIG. 1 is a perspective view showing an inspection system for image display devices according to an embodiment of the present disclosure.

FIG. 2 is a side view showing a structure of an image detection device shown in FIG. 1.

FIG. 3 is an exploded, perspective view showing a stereoscopic image display device according to an embodiment of the present disclosure.

FIG. 4 is a perspective view showing the display panel and the optical member shown in FIG. 3.

FIG. 5 is a block diagram showing the quality analysis device according to an embodiment of the present disclosure.

FIG. 6 is a flowchart illustrating a method for inspecting image quality of an image display device according to an embodiment of the present disclosure.

FIG. 7 is an example of a user interface displayed on a monitor.

FIG. 8 is an example of inspection reference images and quality inspection values stored in the first inspection image storage.

FIG. 9 is an example of test images captured by an image detection device and stored in first image data storage.

FIG. 10 is an example of a method for classifying test images by distortion features via a classification learning process.

FIG. 11 is an example of test images classified through a classification learning process.

FIG. 12 is a flowchart illustrating a method for inspecting image quality of an image display device according to an embodiment of the present disclosure.

FIG. 13 is an example illustrating a test reference image, stereoscopic test images, and image quality inspection values.

### DETAILED DESCRIPTION

Embodiments of the present disclosure are described hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure is thorough and complete, and fully convey the scope of the disclosure to those skilled in the art.

It will also be understood that when a layer is referred to as being “on” another layer or substrate, it can be directly on the other layer or substrate, or intervening layers may also be present therebetween. The same reference numbers may be used to indicate the same components throughout the specification.

It will be understood that, although the terms “first,” “second,” etc. may be used herein to describe various elements, these elements should not be limited by these terms. These terms are only used to distinguish one element from another element. For example, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association. Hereinafter, embodiments of the present disclosure are described with reference to the accompanying drawings.

Embodiments of the present disclosure relates to a method and system for inspecting the image quality of image display devices, such as a stereoscopic or light-field display, using a machine learning program. The system includes an image detection device and a quality analysis device. The image detection device captures display images from an image display device and generates test image data based on the display images. The test image data is then analyzed using a classification learning processor including a machine learning program. The processor analyzes display characteristics of the test image data at the pixel level and classifies the image data into different class labels that reflect image degradation such as blurring, contrast issues, etc.

In some embodiments, the system computes image quality evaluation metrics such as Peak Signal-to-Noise Ratio (PSNR) and Structural Similarity Index Measure (SSIM). These metrics are compared against predetermined reference metrics obtained from reference images that meet a quality standard stored in a first storage unit. Based on the comparison results, an image data analyzer determines whether a display device meets the quality standard. Classification and quality results are then stored and optionally presented to a user via an interface screen.

Embodiments of the present disclosure is capable of inspecting 2D and 3D stereoscopic images generated from the display device. In some aspects, the image detection device includes at least one loading plate configured to position display devices at a predetermined capture position, a plate rotation shaft configured to tilt the loading plate at a predetermined angle, and a body frame configured to adjust the inclination and height of an image capturing device. Accordingly, the system can capture test image data from various angles and viewing conditions to enhance accuracy in detecting display characteristics of the display device. The classified image data is further analyzed by computing numerical evaluation values such as PSNR and SSIM to determine whether the image display device meets a quality standard.

Aspects of the present disclosure provide an inspecting system for image display devices that can accurately classify distortion features (or image quality degradation characteristics) of 2D images and 3D stereoscopic images using machine learning algorithms and programs such as deep learning in a process of inspecting the image quality of stereoscopic display devices.

Aspects of the present disclosure also provide an inspection system for image display devices that can more accurately check image display quality for stereoscopic image display devices by numerically deriving the image quality and visibility of images classified by distortion features (or image quality degradation characteristics).

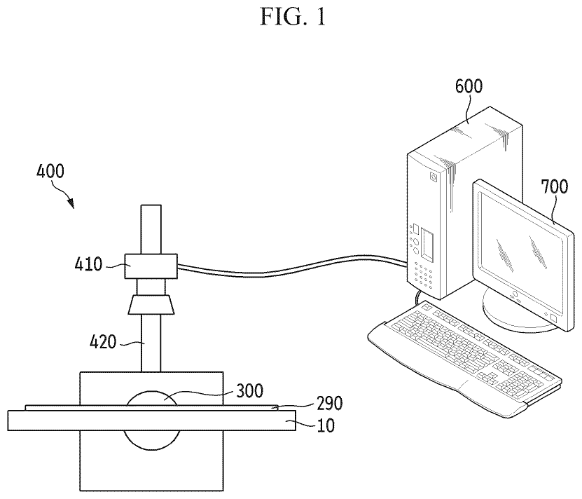

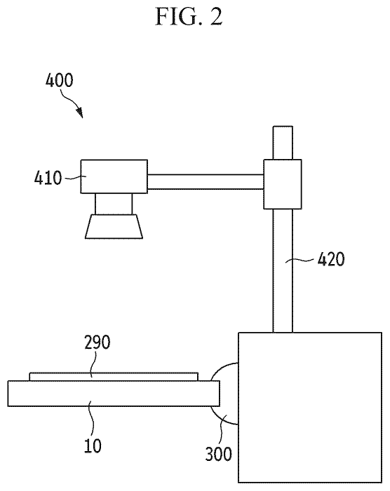

FIG. 1 is a perspective view showing an inspection system for image display devices according to an embodiment of the present disclosure. FIG. 2 is a side view showing a structure of an image detection device shown in FIG. 1.

Referring to FIGS. 1 and 2, the inspection system according to the embodiment includes an image detection device 400 that captures a display image of an image display device 290 (e.g., a stereoscopic display device), and a quality analysis device 600 that inspects the quality or characteristics of the stereoscopic image display devices 290. In some aspects, the image detection device 400 includes a loading plate 10, an image capturing device 410, a body frame 420, and a plate rotation shaft 300. In some aspects, the inspection system further includes a monitor 700.

The image detection device 400 is configured to capture images sequentially displayed on display devices 290 to generate and detect test image data for at least every frame. The image detection device 400 includes at least one loading plate 10, an image capturing device 410, a body frame 420, and a plate rotation shaft 300.

The loading plates 10 of the image detection device 400 is configured to move and position the display devices 290 at a predetermined capture position. As described herein, a capture position may be referred to as a position or location that the image detection device 400 takes an image of the display device 290. For example, the loading plates 10 may be disposed on a rail. The loading plate 10 may move along the rail to position the display devices 290 to the predetermined capture position. In some cases, the loading plates 10 are each fixed to the plate rotation shaft 300 of the body frame 420, so that at least one display device 290 may be loaded and unloaded on a surface of the loading plate 10.

At least one plate rotation shaft 300 may be disposed on one side of the body frame 420 to support at least one loading plate 10. The plate rotation shaft 300 may control a tilt angle of at least one loading plate 10, where the loading plate can be tilted at an angle. The plate rotation shaft 300 can rotate in a predetermined rotation direction.

The body frame 420 controls the inclination of the loading plate 10 on which the stereoscopic image display devices 290 are loaded by using the plate rotation shaft 300. In addition, the body frame 420 includes at least one supporting member that supports the image capturing device 410 to move and be fixed to a height adjustment position so that the capture position and height of the image capturing device 410 are adjusted.

The image capturing device 410 captures images sequentially displayed on display devices 290 to generate and detect test image data for at least every frame. According to an embodiment, the image capturing device 410 includes at least one image sensor, at least one image capturing camera, etc. The display device 290 displays a predetermined test image and is disposed on the loading plate 10. The image capturing device 410 sequentially captures the image displayed on the display device 290. Then, the test image data of the captured display image is aligned at least every frame and transmitted to the quality analysis device 600.

According to some embodiments, the image detection device 400 may capture a plurality of images displayed on a display device 290 to generate the test image data. In some cases, the display device 290 may display a plurality of images. In some cases, the display device 290 may display an image at different incline angles, where the image detection device 400 captures the image displayed at different incline angles. In some cases, a plurality of display devices 290 may be disposed on the loading plate 10, where the image detection device 400 may capture an image for each of the display devices 290. Then, the images captured from each display device 290 is sequentially aligned into frames of the test image data. The test image data may be transmitted to the quality analysis device 600 for further inspections (e.g., testing or analysis).

The quality analysis device 600 classifies the test image data into class labels based on predetermined distortion features (or image quality degradation characteristics) using a pretrained machine learning program. Then, the quality analysis device 600 analyzes image quality evaluation values of the test image data within each class label to determine or inspect whether the display devices 290 meet a predetermined quality standard. Then, the display devices 290 are sorted accordingly.

For example, the quality analysis device 600 includes at least one processing computer or a microprocessor such as a micro controller unit (MCU). The quality analysis device 600 analyzes distortion features (or image quality degradation characteristics) of test image data using a machine learning program such as deep learning that is pretrained and coded in the processing unit of a processing computer. Then, the quality analysis device 600 separates and classifies the test image data for every frame and performs predetermined preprocessing steps. In some cases, the preprocessing steps may include down-conversion of the resolution of the test image data (e.g., downscaling the resolution). In some cases, the preprocessing steps include dividing the test image data into predetermined sizes or resolutions (e.g., performing segmentation) to sort the segmented test image data into the corresponding areas.

To classify the test image data into a plurality of predetermined class labels, the quality analysis device 600 compares and analyzes the display characteristics of the test image data. In some aspects, the display characteristics include the grayscale value, luminance value, brightness, saturation, and color difference for each of the pixels. The quality analysis device 600 analyzes the display characteristic of the test image data in a matrix for each frame (corresponding to each image) or each segmented region using a machine learning program.

In some embodiments, the quality analysis device 600 classifies each piece of test image data into the class labels based on the predetermined distortion features. This classification is performed using the machine learning program based on the analysis results of display characteristics, such as pixel-level variation that occurred in each frame or each segmented region. The classification results are displayed on the monitor 700 or similar output display devices through a separate interface screen.

In some cases, the quality analysis device 600 analyzes image quality evaluation values of the test image data, which has been classified into the class labels, to determine whether the display devices 290 meet a quality standard, and sort the display devices 290 are sorted accordingly.

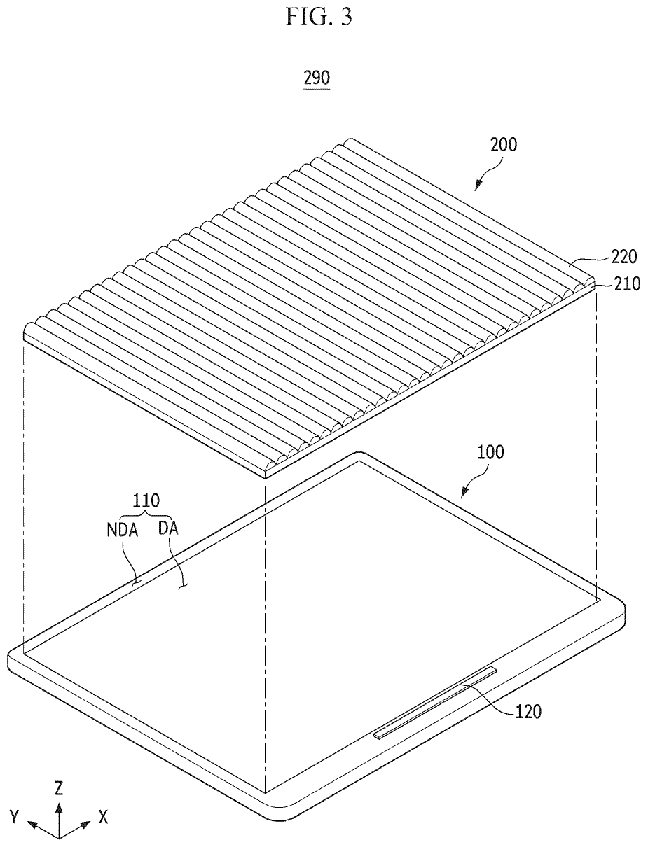

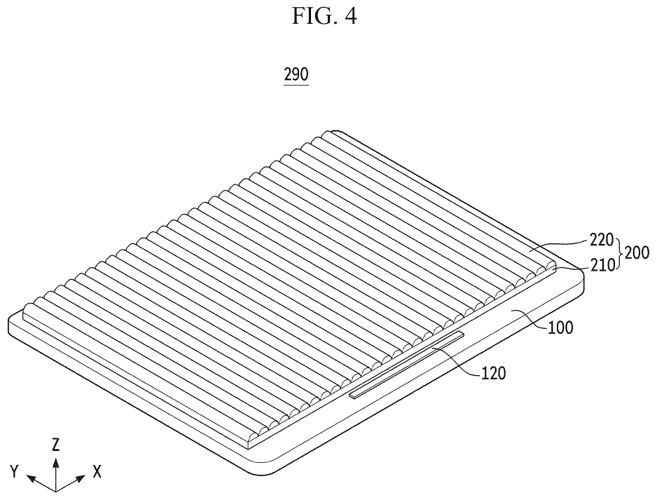

FIG. 3 is an exploded, perspective view showing a stereoscopic image display device according to an embodiment of the present disclosure. FIG. 4 is a perspective view showing the display panel and the optical member shown in FIG. 3.

Referring to FIGS. 3 and 4, the display device 290 may be a stereoscopic image display device including a display module 100 and an optical member 200. In one aspect, the display module 100 may include a display panel 110, a display driver 120. In one aspect, the optical member 200 may include flat portion 210 and stereoscopic lenses 220. The display device 290 separately displays a left-eye image and a right-eye image on the front side of the display device 290 to provide 3D viewing experiences utilizing binocular parallax. Furthermore, the 3D image display device may separately provide images at different viewing angles on the front side of the display device 290 so that different images are displayed at the different viewing angles.

The display device 290 may be a light-field display device that enables different image information to be seen by different eyes of a viewer, respectively. In some cases, this is achieved by disposing the optical member 200 on the front side of the display module 100. For example, the optical member 200 may be disposed on an upper surface of the display module 100. The light-field display device may generate a 3D image by generating a light field with the display module 100 and the 3D optical member 200. As described later, light rays generated in each of the pixels of the display module 100 of the light-field display device form a light field directed to a particular direction (a particular viewing angle and/or a particular viewpoint) by stereoscopic lenses, pinholes or barriers. As a result, 3D image information associated with the particular direction can be provided to the viewer.

The display module 100 may include a display panel 110, a display driver 120, and a circuit board. The display panel 110 may include a display area DA and a non-display areas NDA. The display area DA may include data lines, scan lines, supply voltage lines, and a plurality of pixels connected to the data lines and scan lines. For example, the scan lines may be extended in the first direction (e.g., x-axis direction) and may be spaced apart from one another in the second direction (e.g., y-axis direction). The data lines and the supply voltage lines may be extended in the second direction and may be spaced from one another in the first direction.

Each of the pixels may be connected to at least one scan line, data line, and supply voltage line. Each of the pixels may include thin-film transistors including a driving transistor and at least one switching transistor, a light-emitting element, and a capacitor. When a scan signal is applied from a scan line, each of the pixels receives a data voltage from a data line and supplies a driving current to the light-emitting element based on the data voltage applied to the gate electrode, so that light can be emitted.

The non-display area NDA may be disposed at the edge of the display panel 110 to surround the display area DA. The non-display area NDA may include a scan driver that applies scan signals to scan lines, and pads connected to the display driver 120. For example, the display driver 120 may be disposed on one side of the non-display area NDA, and the pads may be disposed on one edge of the non-display area NDA on which the display driver 120 is disposed.

The display driver 120 may output signals and voltages for driving the display panel 110. The display driver 120 may supply data voltages to data lines. The display driver 120 supplies supply voltage to the supply voltage line, and may supply scan control signals to the scan driver. For example, the display driver 120 may be implemented as an integrated circuit (IC) and may be disposed in the non-display area NDA of the display panel 110 by a chip on glass (COG) technique, a chip on plastic (COP) technique, or an ultrasonic bonding. For example, the display driver 120 may be mounted on a circuit board and connected to the pads of the display panel 110.

The display driver 120 may be configured to assign a viewing point and a viewing point number to each of the pixels based on the relative positions of the pixels with respect to each of the stereoscopic lenses 220 of the optical member 200. In some cases, the display driver 120 aligns predetermined test image data to one or more positions along each horizontal line and vertical line based on the viewing point and the viewing point number assigned to each of the pixels. Then, the display driver 120 may generate data voltages respectively corresponding to the test image data and supply the data voltages to the data lines, so that images can be displayed based on the relative positions of the sub-pixels with respect to the stereoscopic lenses 220.

The optical member 200 may be disposed on the front side of the display module 100 (e.g., an upper layer of the display module 100). The optical member 200 may be attached to a surface of the display module 100 using an adhesive member. The optical member 200 may be attached to the upper surface of the display module 100 using a panel bonding apparatus. For example, the optical member 200 may be implemented as a lenticular lens sheet including the stereoscopic lenses 220. For example, the stereoscopic lenses 220 may be implemented as liquid-crystal lenses that functions as lenses by controlling liquid crystals in liquid-crystal layers. When the stereoscopic lenses 220 are implemented as the lenticular lens sheet, the stereoscopic lenses 220 may be disposed on the flat portion 210.

The flat portion 210 may be disposed directly on the front side of the display module 100 (e.g., the upper surface of the display module 100). For example, a surface of the flat portion 210 facing the display module 100 and the opposite surface of the flat portion 210 opposed to the surface of the flat portion 210 may be parallel to each other. The flat portion 210 may output the light incident from the display module 100 without an alteration. The direction of light passing through the surface of the flat portion 210 may be coincident with the direction of light passing through the opposite surface of the flat portion 210. The flat portion 210 may be formed integrally with the stereoscopic lenses 220, but the present disclosure is not limited thereto.

The stereoscopic lenses 220 may be disposed on the flat portion 210 to change the directions in which lights incident from the display module 100, so that the light exits or propagates toward the front side. For example, the image display lights incident from the rear side of the display module 100 may pass through the flat portion 210 to reach the rear side of the stereoscopic lenses 220. In some cases, the image display lights incident from an upper surface of the display module 100, pass through the flat portion 210, and exits through the upper surface (e.g., the most outer surface) of the stereoscopic lenses 220.

The stereoscopic lenses 220 may be inclined at a predetermined angle with respect to one side of the display module 100. For example, the stereoscopic lenses 220 may be slanted (e.g., inclined) by a predetermined angle from the side of each of the plurality of pixels of the display panel 110. In some cases, the stereoscopic lenses 220 may have a form of half-cylindrical lenses. The predetermined angle may be designed to prevent the color lines of the display device from being perceived by a viewer. For example, the stereoscopic lenses 220 may be implemented as Fresnel Lenses. The shape or type of the stereoscopic lenses 220 is not necessarily limited thereto.

The stereoscopic lenses 220 may be manufactured separately from the flat portion 210, and then attached to the flat portion 210. In some cases, the stereoscopic lenses 220 may be formed integrally with the flat portion 210. For example, the stereoscopic lenses 220 may be embossed into the upper surface of the flat portion 210.

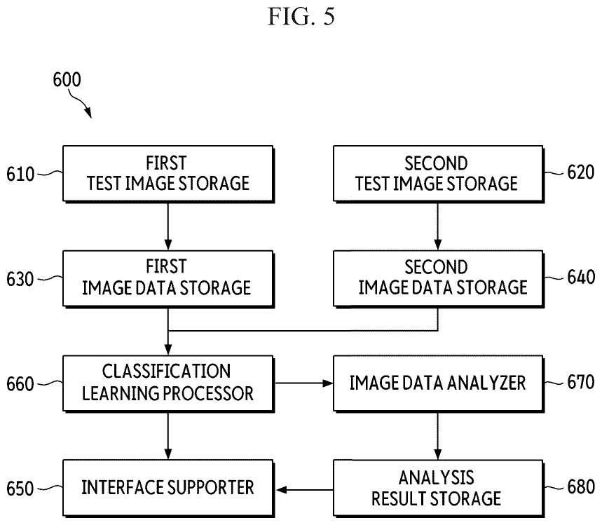

FIG. 5 is a block diagram showing the quality analysis device according to an embodiment of the present disclosure. In some cases, the quality analysis device may be implemented in computing system. Referring to FIGS. 1 and 5, the quality analysis device 600 includes first test image storage 610 and second test image storage 620, first image data storage 630 and second image data storage 640, an interface supporter 650, a classification learning processor 660, an image data analyzer 670, and an analysis result storage 680.

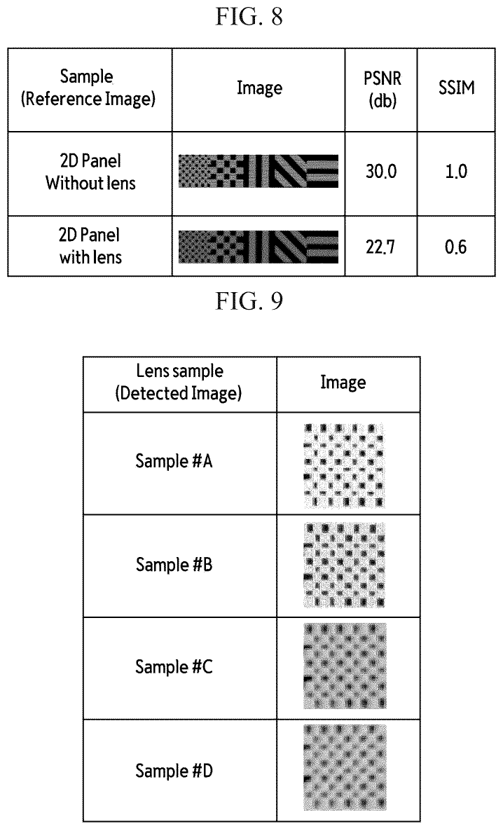

The first test image storage 610 receives first test reference image data for a 2D planar image and quality inspection numerical result for each first test reference image data as experimental values. The first test reference image data and the quality inspection numerical result are stored in a first storage unit. For example, the first test image storage 610 stores planar image data of 2D images displayed from display devices 290 that meet a quality standard. The stored planar image data of the 2D images may be used as first test reference image data. Then, the first test image storage 610 stores quality inspection numerical result for each first test reference image data. The quality inspection numerical result of the first test reference image data may include peak signal-to-noise ratio (PSNR) that represents numerical result of the maximum signal-to-noise ratio, and structural similarity index measure (SSIM) numerical result based on a structural similarity measurement method. In some aspects, the quality standard includes a threshold value of PSNR or SSIM. Further detail on the quality standard is described with reference to FIG. 8.

The second test image storage 620 receives second test reference image data for a 3D stereoscopic image and quality inspection numerical result for each second test reference image data as experimental values. The second test reference image data and the quality inspection numerical result are stored in a first storage unit. For example, the second test image storage 620 stores stereoscopic image data of 3D stereoscopic images displayed from display devices 290 that meet a quality standard. The stored stereoscopic image data of 3D stereoscopic images may be used as second test reference image data. Then, the second test image storage 620 stores quality inspection numerical result for each second test reference image data. The quality inspection numerical result of the second test reference image data may include PSNR numerical result and SSIM numerical result.

The first image data storage 630 receives first test image data for 2D planar images sequentially captured by the image detection device 400 and stores the first test image data for 2D planar images in a second storage unit. For example, the first image data storage 630 separates and sorts the first test image data, which is sequentially received from the image detection device 400 for each frame. Then, the first image data storage 630 performs preprocessing, where the preprocessing includes performing down-scaling the resolution of the first test image data to a predetermined preprocessing resolution or segmenting the first test image data based on a predetermined planar resolution and sort the segments into the corresponding regions. As a result, the first image data storage 630 may store the processed first test image data, where the first test image data has a reduced resolution or segmented into the corresponding regions in the second storage unit.

The second image data storage 640 receives second test image data for 3D stereoscopic images sequentially captured by the image detection device 400 and stores the second test image data for 3D stereoscopic images in a second storage unit. For example, the second image data storage 640 separates and sorts the second test image data, which is sequentially received from the image detection device 400 for each frame. Then, the second image data storage 640 performs preprocessing, where the preprocessing includes performing down-scaling the resolution of the second test image data to a predetermined preprocessing resolution or segmenting the second test image data based on a predetermined planar resolution and sort the segments into the corresponding regions. As a result, the second image data storage 640 may store the processed second test image data, where the second test image data has a reduced resolution or segmented into the corresponding regions in the second storage unit.

The interface supporter 650 provides an interface screen to the monitor 700 so that an inspector can select the first storage unit where the first and second test reference image data is stored and the second storage unit where the first and second test image data is stored. In some cases, the first storage unit includes the first test image storage 610 and the second test image storage 620. In some cases, the second storage unit includes the first image data storage 630 and the second image data storage 640. After selecting the first or the second storage unit, the inspector can further perform classification and evaluation learning processing of the first and second test image data. In addition, the interface supporter 650 supports the interface display operation of the monitor 700 so that the inspector can check the classification results and the numerical image quality evaluation results of the first and second test image data.

The classification learning processor 660 analyzes the display characteristics of the first and second test image data by executing a machine learning program such as deep learning. In doing so, the classification learning processor 660 analyzes the display characteristics for each pixel of the first and second test image data. In some aspects, the display characteristics include grayscale value, luminance value, brightness, saturation, and color difference. The classification learning processor 660 may analyze the display characteristics using the machine learning program. For example, the classification learning processor 660 may analyze the changing state or the amount of change in the planar display characteristics for each pixel by comparing and analyzing the display characteristics for each pixel of the first test image data and the second test image data in a matrix for each frame or each segmented region. Accordingly, the classification learning processor 660 may classify the first test image data and the second test image data into class labels based on predetermined distortion features using the analysis results of the machine learning program. In some cases, the classification results may be transmitted to the interface supporter 650 and the image data analyzer 670. Therefore, the results classified into the classes are displayed on the monitor 700 or similar output display devices through a separate interface screen.

The image data analyzer 670 analyzes image quality evaluation values of the classified first and second test image data to determine whether the stereoscopic image display devices 290 meet a quality standard. For example, the image data analyzer 670 sequentially calculates PSNR numerical result and SSIM numerical result of the classified first and second test image data by using predetermined PSNR numerical detection formula and SSIM numerical detection formula, respectively. For example, the PSNR detection formula and SSIM numerical detection formula can be represented, respectively, as below:

$$M ( width ) , N ( height ) , I ( m , n ) = ¿ data value of m , n coordinates , MAX = RGB pixel gray value I ( Luminance ) , c ( Contrast ) , s ( Structure ) .$$

The image data analyzer 670 compares at least one of the PSNR numerical result or the SSIM numerical result for the first and second test image data, with at least one of the image quality inspection numerical result for the first and second test reference image data. Then, the image data analyzer 670 may determine whether a display device 290 meets a quality standard. For example, when first and second test image data having numerical result higher than at least one image quality inspection numerical result, the display device 290 is considered to meet a quality standard. For example, when the first and second test image data having numerical result lower than or equal to at least one image quality inspection numerical result, the display device 290 is considered to have failed the quality standard.

In some embodiments, the image data analyzer 670 may sequentially compare at least one of the PSNR numerical result or the SSIM numerical result for the first and second test image data, with the predetermined reference numerical result. In some cases, for example, the image data analyzer 670 may determine that a display device 290 meets a quality standard when the first and second test image data having numerical result is higher than the reference numerical result. For example, the image data analyzer 670 may determine that a display device 290 fails to meet a quality standard when the first and second test image data having numerical result is lower than or equal to the reference numerical result.

The analysis result storage 680 stores the results of the classified first and second test image data, and the results of the stereoscopic image display devices 290 that have met the quality standard. In some cases, the analysis result storage 680 transmits the classification results and the determination results to the interface supporter 650. In some cases, the interface supporter 650 may transmit the results to be displayed on the monitor 700.

According to some embodiments, the quality analysis device 600 is configured to receive test image data of one or more display devices 290 and to determine whether each of the display device 290 meets a quality standard. For example, the first test image storage 610 is configured to receive first test reference image data and quality metrics for a 2D planar image corresponding to a display devices that meets the quality standard. Similarly, the second test image storage 620 is configured to receive a second test reference image data and quality metrics for a 3D stereoscopic image corresponding to a display device 290 that meets the quality standard. The first image data storage 630 is configured to receive the first test image data for 2D planar images captured by the image detection device 400. In some embodiments, the first image data storage 630 is configured to down-scale the first test image data, and store the processed data. Similarly, the second image data storage 640 is configured to receive second test image data for 3D stereoscopic images captured by the image detection device 400. In some embodiments, the second image data storage 640 is configured to down-scale the second test image data, and store the processed data.

According to some embodiments, the processed data from the first image data storage 630 and the second image data storage 640 are combined with the data stored in the first test image storage 610 and the second test image storage 620, and the combined data are provided to the interface supporter 650. The interface supporter 650 is configured to provide user interface for a user to select and/or test the data, show classification and/or quality results. In some embodiments, the classification learning processor 660 is configured to receive the combined data and analyze the combined data using a machine learning program. For example, the classification learning processor 660 is configured to analyze the display characteristics on a pixel-level. The classification learning processor 660 generates a classification result (e.g., image distortion types) for the test images (e.g., the test data received from the image detection device 400).

In some embodiments, the image data analyzer 670 is configured to receive the classification result and the reference data (e.g., the first test reference image data and the second test reference image data) to generate a test result indicating whether a display device 290 meets a quality standard. For example, the image data analyzer 670 calculates the PSNR and SSIM for each of the test images and compares the result with the reference data. The test result is then provided to an analysis result storage 680. In some cases, the analysis result storage 680 is configured to store the test results, and optionally transmit the test result to the interface supporter 650 for displaying.

In some cases, the classification learning processor 660 includes a machine learning model. The machine learning model is a computational algorithm or system designed to automatically identify patterns, make predictions, or perform specific tasks such as image classification or quality analysis without the need for explicit rule-based programming. The model relies on machine learning parameters, also known as weights, which define how the model behaves when processing input data. In some cases, these parameters learned from training data during a process that aims to minimize a loss function or maximize a performance metric. Through optimization techniques such as gradient descent or stochastic gradient descent, the model iteratively adjusts its parameters to reduce the error between its predicted outputs and the actual target results. Once trained, the model uses these learned parameters to make accurate predictions on new, unseen data.

In some cases, the machine learning model may include a transformer network, a specialized type of deep neural network originally developed for natural language processing tasks. A transformer network may include an encoder-decoder architecture, where each component is composed of multiple layers containing multi-head attention mechanisms and feed-forward neural networks. The model processes sequences of data by embedding inputs into an n-dimensional space and using positional encoding to retain sequence order. The attention mechanism within a transformer identifies relationships between different parts of the input sequence using query, key, and value vectors (Q, K, V), allowing the model to focus on the most relevant parts of the data at each step. This architecture is capable of capturing complex relationships and dependencies in structured or sequential data.

In some embodiments, the model is trained using reference image data (e.g., 2D planar images and 3D stereoscopic images) along with known image quality metrics including PSNR (Peak Signal-to-Noise Ratio) and SSIM (Structural Similarity Index Measure). During inference, the system captures new test images from display devices 290 and preprocesses the data before inputting into the machine learning model. The model then analyzes display characteristics for each pixel, including luminance, brightness, saturation, grayscale, and color differences, and classifies the images based on learned distortion features or visual differences. These classification results are further evaluated by the image data analyzer, which compares the predicted image quality metrics against reference data to determine whether a display device meets the required quality criteria. Accordingly, the machine learning model can generate a result that indicates whether a display device 290 meets the quality standard.

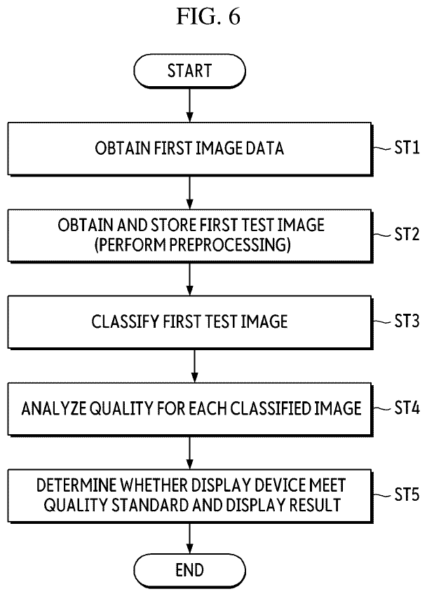

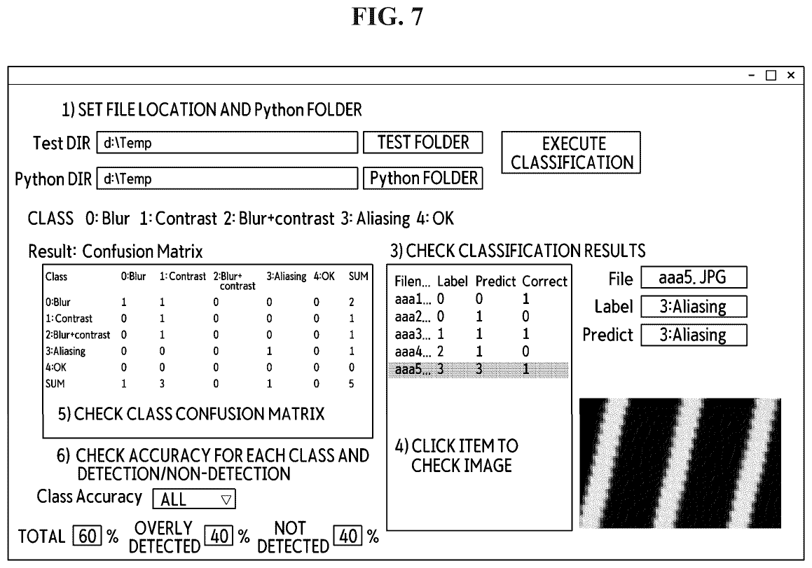

FIG. 6 is a flowchart illustrating a method for inspecting image quality of an image display device according to an embodiment of the present disclosure. FIG. 7 is an example of a user interface displayed on a monitor.

Referring to FIGS. 6 and 7, the interface supporter 650 provides an interface screen to the monitor 700 so that an inspector (or a user) can select the first storage unit where the first test reference image data is stored and the second storage unit where the first test image data is stored. Then, the user can perform classification and evaluation processing of the first test image data using the quality analysis device 600.

In the first storage unit (e.g., Test DIR storage unit), planar image data of 2D images displayed from display devices 290 that meet the quality standard may be stored as first test reference image data. In some cases, the first test image storage 610 may store first test reference image data for 2D planar images and quality inspection numerical result for each first test reference image data in the first storage unit. In addition, the first test reference image data and the image quality inspection numerical result for each first test reference image data stored in the first storage unit may be used as reference image data or reference inspection numerical result (step ST1). For example, at step ST1, the system obtains the first image data. FIG. 8 is an example of inspection reference images and quality inspection values stored in the first test image storage. Referring to FIG. 8, the first test image storage 610 stores the planar image data of 2D images displayed from display devices 290 that met the quality standard is stored in the first storage unit as first test reference image data. The first test reference image data may include image data of a 2D planar image displayed with the optical member 200 including a stereoscopic lens, and image data of a 2D planar image displayed without the optical member 200.

The first test image storage 610 stores image quality inspection numerical result for each first test reference image data with the corresponding first test reference image data. The image quality inspection numerical result of the first test reference image data may include at least one of PSNR numerical result indicating the maximum signal-to-noise ratio, and SSIM numerical result based on a structural similarity measurement method as reference numerical result.

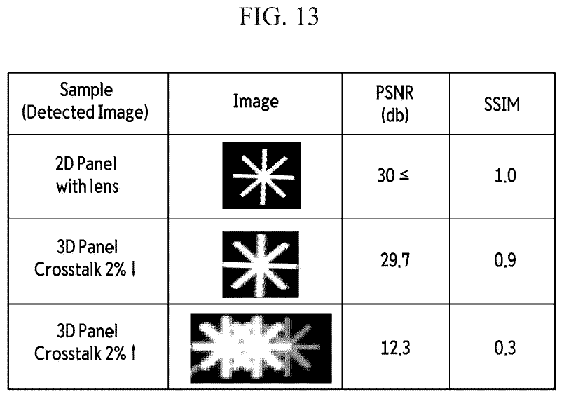

In some embodiments, the quality standard includes a threshold value of PSNR or SSIM. For example, for image data of a 2D planar image displayed without the optical member 200, the PSNR may be 30.0 and the SSIM may be 1.0. These threshold values may be used to indicate whether a display device 290 meets the quality standard. For example, when the PSNR value or the SSIM value of a test image data of a display device 290 is higher than the threshold value, the display device 290 may meet the quality standard. In some cases, when the PSNR value or the SSIM value of a test image data of a display device 290 is lower than the threshold value, the display device 290 may fail to meet the quality standard. In some cases, for example, for image data of a 2D planar image displayed with the optical member 200, the PSNR may be 22.7 and the SSIM may be 0.6. The threshold values of the quality standard are not limited thereto. Further detail on the quality standard of reference image data for 3D stereoscopic images is described with reference to FIG. 13.

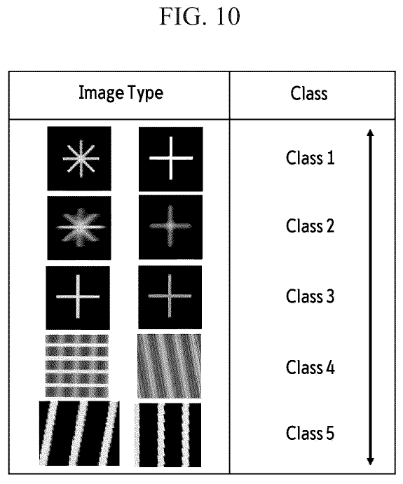

FIG. 9 is an example of test images captured by an image detection device and stored in first image data storage. Referring to FIG. 9, the first image data storage 630 receives first test image data for 2D planar images sequentially captured by the image detection device 400 and stores the first test image data in a second storage unit (e.g., python DIR shown in FIG. 7). For example, the first image data storage 630 separates and sorts the first test image data sequentially obtained from the image detection device 400 for each frame (e.g., Sample # A to Sample # D).

Then, the first image data storage 630 down-samples the first test image data to a predetermined preprocessing resolution or segments the first test image data to a predetermined planar resolution to sort the segmented first test image data into a corresponding region. As a result, the first image data storage 630 may store the down-sampled first test image data or the segmented first test image data in the second storage unit (e.g., Python DIR) (step ST3). For example, at step ST3, the system classifies the first test image data to obtain the classified test image data.

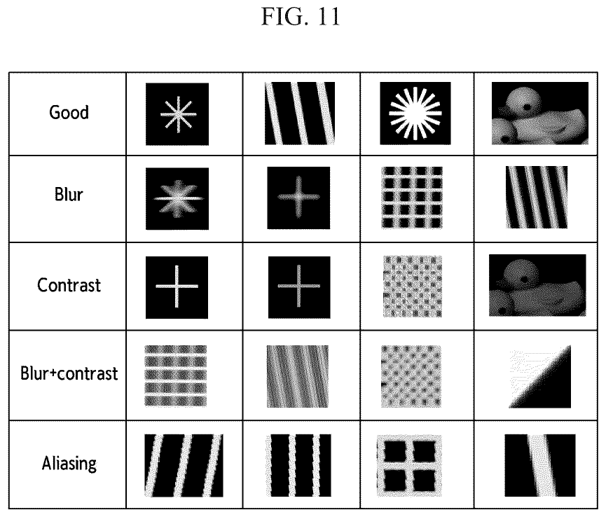

FIG. 10 is an example of a method for classifying test images by distortion features via a classification learning process. Referring to FIG. 10, the classification learning processor 660 analyzes the display characteristics for each pixel of the first test image data using a machine learning program. In one aspect, the display characteristics include grayscale value, luminance value, brightness, saturation, and color difference. In some cases, the classification learning processor 660 may analyze the changing state or the amount of change in the planar display characteristics for each pixel of the first test image data by comparing and analyzing them in a matrix structure for each frame or each segment.

The classification learning processor 660 may classify the first test image data into a set of class labels (e.g., Class 1 to Class 5) by predetermined distortion features based on the analysis results of the machine learning program. Then, the classification learning processor 660 may transmit the classification results to the interface supporter 650 and the image data analyzer 670. Therefore, the results classified into the classes are displayed on the monitor 700 and similar output display panels through a separate interface screen (step ST3).

FIG. 11 is an example of test images classified through a classification learning process. Referring to FIGS. 10 and 11, the machine learning program classifies the image distortion features into five class labels, labeled as Class 1 to Class 5. In one aspect, these class labels include: a first classification class “Class 1” representing a clear and high-quality image (e.g., a good case); a second classification class “Class 2” representing a blurring phenomenon (e.g., a blur case); a third classification class “Class 3” representing a strong contrast (e.g., a contrast case); a fourth classification class “Class 4” representing a blurring phenomenon and strong contrast; and a fifth classification class “Class 5” representing an aliasing phenomenon derived due to a change in resolution. The results classified into the class labels Class 1 to Class 5 in the classification learning processor 660 are displayed on the monitor 700 or the like through the interface screen, as shown in FIG. 7.

In some embodiments, the image data analyzer 670 computes the image quality evaluation values of the first test image data that are classified into the class labels Class 1 to Class 5, and analyzes the detected image quality evaluation values to determine whether the stereoscopic image display devices 290 meet the quality standard. For example, the image data analyzer 670 calculates PSNR numerical result and SSIM numerical result for the first test image data that are classified into the class labels Class 1 to Class 5 by using predetermined PSNR numerical detection formula and SSIM numerical detection formula, respectively.

The image data analyzer 670 compares at least one of the PSNR numerical result and the SSIM numerical result for the first test image data, with at least one of the image quality inspection numerical result (e.g., PSNR and SSIM numerical result) for the first test reference image data. Then, the image data analyzer 670 determines that a display device 290 meets the quality standard when the first test image data has a numerical result higher than at least one image quality inspection numerical result. In some cases, the image data analyzer 670 may determine that a display device 290 fails to meet the quality standard when the first test image data has a numerical result lower than or equal to at least one image quality inspection numerical result (step ST4). At step ST4, the system analyzes the quality for each classified image.

The analysis result storage 680 stores the results of the classified first test image data, and the quality results of the stereoscopic image display devices 290. In some cases, analysis result storage 680 transmits the classification results and the quality results to the interface supporter 650. Therefore, the results of classified first test image data and the quality results of the stereoscopic image display devices 290 are displayed on the monitor 700 and the like through a separate interface screen (step ST5). At operation ST5, the system determines whether a display device meets a quality standard and display the result.

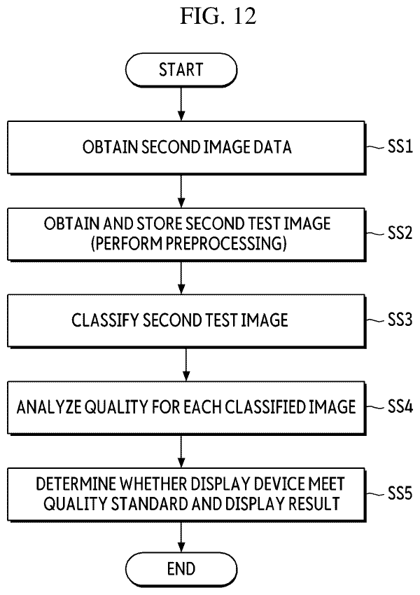

FIG. 12 is a flowchart illustrating a method for inspecting image quality of an image display device according to an embodiment of the present disclosure. FIG. 13 is an example illustrating a test reference image, stereoscopic test images, and image quality inspection values.

Referring to FIGS. 12 and 13, initially, the interface supporter 650 provides an interface screen to the monitor 700 so that a user can select the first storage unit (Test DIR) where the first test reference image data is stored and the second storage unit (Python DIR) where the first test image data is stored. Then, the user can perform classification and evaluation processing of the first test image data using the quality analysis device 600.

At step SS1, the system obtains second image data. For example, in the first storage unit (e.g., Test DIR storage unit), 3D stereoscopic image data from the display devices 290 that meet the quality standard may be stored as second test reference image data. In some cases, the second test image storage 620 may store second test reference image data for 3D stereoscopic images and image quality inspection numerical result for each second test reference image data in the first storage unit. In addition, the second test reference image data and the image quality inspection numerical result for each second test reference image data stored in the first storage unit may be used as reference image data or reference inspection numerical result. The second test reference image data may be stored as image data of 3D stereoscopic images with different crosstalk ratios (e.g., crosstalk ratios of 2% or more, or 2% or less) applied with the optical member 200 including stereoscopic lenses.

According to some embodiments, the quality standard includes a threshold value of PSNR or SSIM for display panels that output 3D stereoscopic images. For example, for image data of 3D stereoscopic images with crosstalk ratios of 2% or less, the PSNR may be 29.7 and the SSIM may be 0.9. These threshold values may be used to indicate whether a display device 290 meets the quality standard. For example, when the PSNR value or the SSIM value of a test image data of a display device 290 is higher than the threshold value, the display device 290 may meet the quality standard. In some embodiments, for image data of 3D stereoscopic images with crosstalk ratios of 2% or more, the PSNR may be 12.3 and the SSIM may be 0.3. These threshold values may be used to indicate whether a display device 290 meets the quality standard. The threshold values of the quality standard are not limited thereto.

Then, the second image data storage 640 receives second test image data for 3D stereoscopic images sequentially captured by the image detection device 400 and stores the second test image data in a predetermined second storage unit (e.g., Python DIR). The second image data storage 640 separates and sorts the second test image data sequentially received from the image detection device 400 for each frame. Then, the second image data storage 640 downsamples the resolution of the second test image data to a predetermined preprocessing resolution or segments the second test image data to a predetermined planar resolution to sort the segments into the corresponding region. As a result, the second image data storage 640 may store the downsampled second test image data or the segmented second test image data in the second storage unit (Python DIR) (step SS2). At operation SS2, the system obtains and stores the second test image data.

The classification learning processor 660 analyzes the display characteristics for each pixel of the second test image data using the machine learning program. For example, the display characteristics include grayscale value, luminance value, brightness, saturation, and color difference. In some cases, the classification learning processor 660 may analyze the changing state or the amount of change in the planar display characteristics for each pixel of the second test image data by comparing and analyzing the changes in a matrix structure for each frame or each segment.

The classification learning processor 660 may classify the second test image data into class labels (e.g., Class 1 to Class 5) based on the predetermined distortion features using the analysis results of the machine learning program. In some cases, the classification learning processor 660 may transmit the classification results to the interface supporter 650 and the image data analyzer 670. Therefore, the classification results are displayed on the monitor 700 and the like through a separate interface screen (step SS3). At step SS3, the system classifies the second test image.

The image data analyzer 670 detects the image quality evaluation values of the classified second test image data classified into the class labels Class 1 to Class 5, and analyzes the detected image quality evaluation values to determine whether the stereoscopic image display devices 290 meet the quality standard. For example, the image data analyzer 670 calculates PSNR numerical result and SSIM numerical result for the classified second test image data using predetermined PSNR numerical detection formula and SSIM numerical detection formula, respectively.

The image data analyzer 670 compares at least one of the PSNR numerical result and the SSIM numerical result for the second test image data, with at least one of the image quality inspection numerical result (e.g., PSNR and SSIM numerical results) for the second test reference image data. Then, the image data analyzer 670 determines that a display device 290 meets the quality standard when the second test image data has a numerical result higher than at least one image quality inspection numerical result. In some cases, the image data analyzer 670 may determine that a display device 290 fails to meet the quality standard when the second test image data has a numerical result lower than or equal to at least one image quality inspection numerical result (step SS4). At step SS4, the system analyze the quality for each classified image.

The analysis result storage 680 stores the classification results and the quality results of the stereoscopic image display devices 290. In some cases, the analysis result storage 680 transmits the classification results and the quality results to the interface supporter 650. Therefore, the classification results and the quality results of the stereoscopic image display devices 290 are displayed on the monitor 700 and the like through a separate interface screen (step SS5). At step SS5, the system determines whether a display device meets the quality standard and displays the results.

In the detailed description, those skilled in the art will appreciate that one or more variations and modifications can be made to the preferred embodiments without substantially departing from the spirits and principles of the present disclosure. Therefore, the disclosed preferred embodiments of the disclosure are used in a generic and descriptive sense and not for purposes of limitation.

What is claimed is:

1. An inspection system for image display devices, comprising:
an image detection device configured to capture display images of display devices and to obtain test image data corresponding to the display images; and
a quality analysis device configured to classify the test image data into a plurality of class labels based on predetermined distortion features using a machine learning program to obtain classified test image data, and to determine whether the display devices meet a quality standard by analyzing image quality evaluation values of the classified test image data, wherein the quality standard includes at least one threshold value of a Peak Signal-to-Noise Ratio (PSNR) value or Structural Similarity Index Measure (SSIM).

2. The system of claim 1, wherein the image detection device comprises:
at least one loading plate configured to arrange the display devices at a predetermined position;
an image capturing device configured to capture images sequentially displayed on the display devices to generate the test image data;
a body frame configured to control an inclination of the at least one loading plate on which the display devices are disposed on and to adjust a capture position and a height of the image capturing device; and
at least one plate rotation shaft configured to support the at least one loading plate and is disposed on one side of the body frame to control a tilt angle of the at least one loading plate.

3. The system of claim 2, wherein the quality analysis device is configured to:
downsample the test image data to obtain downsampled test image data;
classify the downsampled test image data by comparing display characteristics of the test image data and the downsampled test image data in a matrix using the machine learning program to obtain the classified test image data; and
determine whether the display devices meet the quality standard based on the classified test image data.

4. The system of claim 2, wherein the quality analysis device comprises:
a first test image storage configured to store first test reference image data of a 2D planar image and quality inspection numerical result for the first test reference image data;
a first image data storage configured to sequentially receive and store first test image data of a 2D planar image captured by the image detection device;
an interface supporter configured to support an interface screen including a selection of a first storage unit and a second storage unit, and a result indicator representing a classification result and a quality result of the first test image data, wherein the first storage unit stores the first test reference image data and the second storage unit store the first test image data;
a classification learning processor configured to generate the classification result by analyzing display characteristics of the first test image data using the machine learning program, and to classify the first test image data based on results of analyzing the display characteristics;
an image data analyzer configured to generate the quality result by determining whether the display devices meet the quality standard; and
an analysis result storage configured to store the classification result and the quality result, and to transmit the classification result and the quality result to the interface supporter.

5. The system of claim 4, wherein:
the first image data storage is configured to downsample the first test image data to a predetermined preprocessing resolution to obtain downsampled first test image data, to segment the first test image data based on a predetermined planar resolution to obtain segmented first test image data, and to store the downsampled first test image data and the segmented first test image data.

6. The system of claim 5, wherein:
the classification learning processor is configured to analyze at least one display characteristics for each pixel of each of the first test image data using the machine learning program, to compute a changing state of the display characteristics for each pixel of each of the first test image data, and to classify the first test image data based on the predetermined distortion features and the changing state.

7. The system of claim 6, wherein:
the image data analyzer is configured to compute PSNR numerical result and SSIM numerical result for the classified first test image data, and to determine whether the display devices meet a quality standard by comparing at least one of the PSNR numerical result and the SSIM numerical result for the first test image data with at least one of an image quality inspection numerical result of the first test reference image data.

8. The system of claim 4, wherein the quality analysis device further comprises:
a second test image storage configured to store second test reference image data of a 3D stereoscopic image and quality inspection numerical result for the second test reference image data; and
a second image data storage configured to sequentially receive and store second test image data of a 3D stereoscopic image captured by the image detection device.

9. The system of claim 8, wherein:
the second image data storage is configured to downsample the second test image data to a predetermined preprocessing resolution to obtain downsampled second test image data, to segment the second test image data based on a predetermined planar resolution to obtain segmented second test image data, and to store the downsampled second test image data and the segmented second test image data.

10. The system of claim 8, wherein:
the interface supporter configured to support an interface screen including a selection of the first storage unit and the second storage unit, and a result indicator representing a classification result and a quality result of the second test image data, wherein the first storage unit stores the second test reference image data and the second storage unit store the second test image data,
wherein the classification learning processor configured to generate a classification result by analyzing the display characteristics of the second test image data, and to classify the second test image data based on results of analyzing the display characteristics,
wherein the image data analyzer configured to generate a quality result by determining whether the display devices meet the quality standard, and
wherein the analysis result storage configured to store the classification result and the quality result, and to transmit the results of classifying and the classification result and the quality result to the interface supporter.

11. The system of claim 10, wherein:
the classification learning processor is configured to analyze at least one display characteristics for each pixel of each of the second test image data using the machine learning program, to compute a changing state of the display characteristics for each pixel of each of the second test image data, and to classify the second test image data based on the predetermined distortion features and the changing state.

12. The system of claim 11, wherein:
the image data analyzer is configured to compute PSNR numerical result and SSIM numerical result for the classified second test image data, and to determine whether the display devices meet the quality standard by comparing at least one of the PSNR numerical result and the SSIM numerical result for the second test image data with at least one of an image quality inspection numerical result of the second test reference image data.

13. An inspection system for image display devices, comprising:
an image detection device configured to capture display images of display devices and to obtain test image data corresponding to the display images; and
a quality analysis device configured to classify the test image data into a plurality of class labels based on predetermined distortion features using a machine learning program to obtain classified test image data, and to determine whether the display devices meet a quality standard by analyzing image quality evaluation values of the classified test image data classified,
wherein the quality analysis device is configured to downsample the test image data to obtain downsampled test image data, and to classify the test image data based on the downsampled test image data.

14. The system of claim 13, wherein the image detection device comprises:
at least one loading plate configured to arrange the display devices at a predetermined position;
an image capturing device configured to capture images sequentially displayed on the display devices to generate the test image data;
a body frame configured to control an inclination of the at least one loading plate on which the display devices are disposed on and to adjust a capture position and a height of the image capturing device; and
at least one plate rotation shaft configured to support the at least one loading plate and is disposed on one side of the body frame to control a tilt angle of the at least one loading plate.

15. The system of claim 14, wherein the quality analysis device comprises:
a first test image storage configured to store first test reference image data of a 2D planar image and quality inspection numerical result for the first test reference image data;
a first image data storage configured to sequentially receive and store first test image data of a 2D planar image captured by the image detection device;
an interface supporter configured to support an interface screen including a selection of a first storage unit and a second storage unit, and a result indicator representing a classification result and a quality result of the first test image data, wherein the first storage unit stores the first test reference image data and the second storage unit stores the first test image data;
a classification learning processor configured to generate the classification result by analyzing display characteristics of the first test image data busing the machine learning program, and to classify the first test image data based on results of analyzing the display characteristics;
an image data analyzer configured to generate the quality result by determining whether the display devices meet the quality standard; and
an analysis result storage configured to store the classification result and the quality result, and to transmit the classification result and the quality result to the interface supporter.

16. A method for inspecting image quality of an image display device, comprising:
obtaining, using an image detection device, test image data from a display image of an image display device;
classifying, using a classification learning processor, the test image data to obtain classified test image data based on display characteristics of the test image data using a machine learning program;
computing, using an image data analyzer, image quality evaluation metrics for the classified test image data; and
determining, using the image data analyzer, whether the image display device meets a quality standard based on a comparison between the computed image quality evaluation metrics and predetermined reference metrics.

17. The method of claim 16, wherein:
the image quality evaluation metrics includes a Peak Signal-to-Noise Ratio (PSNR) value and a Structural Similarity Index Measure (SSIM) value.

18. The method of claim 16, further comprising:
storing reference image data and reference metrics of a reference display image in a first storage unit, and storing the test image data in a second storage unit.

19. The method of claim 16, wherein:
the test image data comprises 2D planar images and 3D stereoscopic images obtained at different tilt angles of the image display device.

20. The method of claim 16, further comprising:
displaying a selection between a first storage unit and a second storage unit and presenting a result indicator showing a classification result and a quality result of the display device.
